(19) United States
(12) Patent Application Publication
(10) Pub. No.: US 2024/0111488 A1
(43) Pub. Date: Apr. 4, 2024

(54) DATA PROCESSING APPARATUS AND METHOD

(71) Applicants: The University Court of the University of Edinburgh, Edinburgh (GB); CANON MEDICAL SYSTEMS CORPORATION, Tochigi (JP)

(72) Inventors: Pedro SANCHEZ, Edinburgh (GB); Sotirios TSAFTARIS, Edinburgh (GB); Xiao LIU, Edinburgh (GB); Alison O’NEIL, Edinburgh (GB)

(73) Assignees: The University Court of the University of Edinburgh, Edinburgh (GB); CANON MEDICAL SYSTEMS CORPORATION, Tochigi (JP)

(21) Appl. No.: 18/468,823

(22) Filed: Sep. 18, 2023

Related U.S. Application Data
(60) Provisional application No. 63/408,250, filed on Sep. 20, 2022.

(51) Int. Cl. G06F 7/24; G06F 17/18

(52) U.S. Cl. CPC G06F 7/24; G06F 17/18

(57) ABSTRACT

A data processing apparatus comprises: a memory configured to store a trained model; and processing circuitry configured to: receive at least one dataset that comprises d variables and n samples; determine variances associated with the variables by processing the dataset using the model; determine an order of the variables based on the determined variances, including iteratively removing at least one node or variable represented by said at least one node thereby to determine the order.

### FIELD

Embodiments described herein relate generally to a method and apparatus for processing data, for example for training and using a model to determine causal relationships between data, for example between different variables. The method and apparatus may generate causal graphs representing the causal relationships.

### BACKGROUND

Knowledge of causal relations is important for reasoning about interventions (e.g. drugs, surgery or other medical treatments). Given a set of variables, it can be desirable to discover the underlying causal graph (assumed to be a directed acyclic graph i.e. DAG).

Causal discovery requires doing a combinatorial search. However, solving it with a greedy combinatorial optimisation can be costly and does not scale to high-dimensional problems.

The problem can be simplified by first discovering only the ordering of the variables following the topology of the graph—starting with the children i.e. leaf nodes, followed by parents, until we reach the root node of the graph. Thus, causal ordering algorithms search not over the space of structures, but over the space of orderings, then secondly select for each ordering the best network consistent with it as a follow-on step. This search space is much smaller, makes more global search steps, has a lower branching factor, and avoids costly acyclicity checks.

By way of further background, Rolland, P et al, Score Matching Enables Causal Discovery of Nonlinear Additive Noise Models. ICML 2022, pp. 18741-1 8753 show that the score of a distribution can be used to find leaves in a graph. In particular, they observe that the score s:

$${Var}_{X} [ \frac{\partial {s}_{j} ( X )}{\partial {x}_{j}} ] = 0$$

is true if, and only if, j is a leaf node. In practice, this observation can be used to iteratively find leaf nodes. Note that the derivative in the equation corresponds to the diagonal of a matrix Hessian. Rolland, P et al. uses the equation to find and remove leaves iteratively. After finding each leaf, the corresponding variable is removed from X and the sⱼ is recomputed. The output is the topological ordering of a causal graph.

By way of additional background, training to denoise data can approximate learning the score of a data distribution, see Vincent., P, A Connection between Score Matching and Denoising Autoencoders, Neural Computation 2011, 23(7), 1661-1674 and Hyvarinen, A , Estimation of Non-Normalized Statistical Models by Score Matching, JMLR 2005 6(24), 695-709. Diffusion probabilistic models (DPMs) can learn to denoise data at different noise scales, as discussed in Song, A. et al Score-Based Generative Modeling through Stochastic Differential Equations ICLR 2021. In particular, training diffusion models can be considered equivalent to minimising the following mean squared error:

$${θ}^{*} = {arg min}_{θ} {𝔼}_{{x}_{0} , t , ϵ} [ λ ( t ) {‖ {ϵ}_{θ} ( {x}_{t} , t ) - ϵ ‖}_{2}^{2} ]$$

Known methods for causal discovery are generally slow, therefore causal ordering algorithms have been employed as a speed-up by first estimating the topological order (e.g. from children up to the root node) followed by determining causal relations. However, these methods still do not scale to large datasets. For example, current SOTA methods are computationally intensive, making them impractical for use with large datasets, for example with orders of magnitude more than 10³ samples.

### BRIEF DESCRIPTION OF THE DRAWINGS

Embodiments are now described, by way of non-limiting example, and are illustrated in the following figures, in which:

FIG. 1 is a schematic illustration of an apparatus in accordance with an embodiment;

FIG. 2 is an illustration of an unsorted graph and a topologically sorted graph resulting from application of a causal discovery process;

FIGS. 3 and 4 are schematic illustrations of a process of learning causal relations between d variables using a dataset of n samples;

FIG. 5 is a flow chart illustrating in overview a process according to an embodiment;

FIG. 6 is a schematic illustration showing the process of FIG. 6 applied to a set of four input variables A, B, C and D by way of example;

FIG. 7 is a plot showing run time in seconds for different sample sizes, for discovery of causal graphs with 500 nodes;

FIGS. 8 and 9 shows results of experiments on synthetic data graphs for graphs with nodes using the method according to an embodiment; and

FIGS. 10 and 11 are plots that illustrate the variation in accuracy of a method according to an embodiment, as the dataset size is scaled up for datasets with 500 variables and increasing numbers of data samples n (FIG. 10) and as the batch size for computing the Hessian variance is changed (FIG. 11).

### DETAILED DESCRIPTION

According to an embodiment, a data processing apparatus comprises a memory configured to store a trained model, and processing circuitry configured to receive at least one dataset that comprises d variables and n samples, determine variances associated with the variables by processing the dataset using the model, determine an order of the variables based on the determined variances, including iteratively removing at least one node or variable represented by said at least one node thereby to determine the order.

According to an embodiment, a data processing method comprises storing a trained model, receiving at least one dataset that comprises d variables and n samples, determining variances associated with the variables by processing the dataset using the model, and determining an order of the variables based on the determined variances including iteratively removing variables and/or nodes thereby to determine the order.

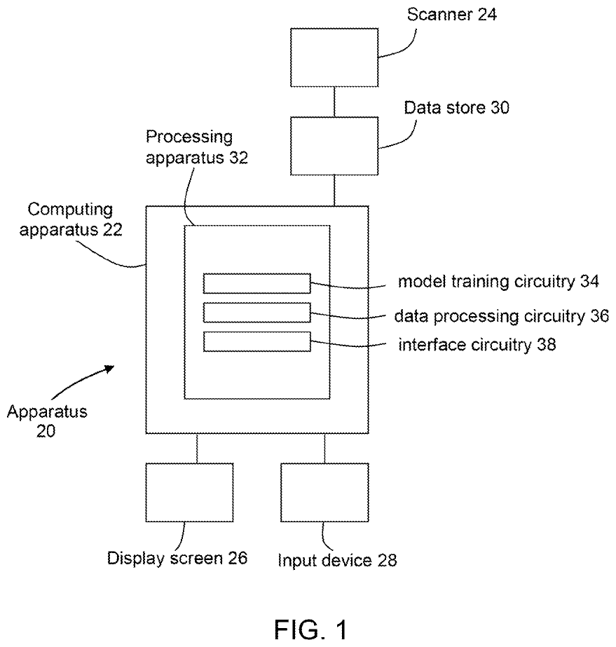

A data processing apparatus 20 according to an embodiment is illustrated schematically in FIG. 1. In the present embodiment, the data processing apparatus 20 is configured to process medical data. In other embodiments, the data processing apparatus 20 may be configured to process any other appropriate data.

The data processing apparatus 20 comprises a computing apparatus 22, which in this case is a personal computer (PC) or workstation. The computing apparatus 22 is connected to a display screen 26 or other display device, and an input device or devices 28, such as a computer keyboard and mouse.

The computing apparatus 22 is configured to obtain data sets from a data store 30. The data sets have been obtained or generated using any suitable apparatus or from any suitable source. For example, the data sets can include or represent drug dosages given to a patient or other subject, physiological or other measurements performed on the patient (for example, blood pressure, temperature, heart rate, blood oxygenation, electrocardiograph or other electrical measurements, vision or hearing-related measurements, measurements of any of the patient's senses or reactions, or any other measurements, and/or age, height, weight or other patient data. The data sets can include variations of any or all of the data with time, either or both measurements as a function of time taken during a particular measurement procedure on a particular occasion, and data taken during different measurement procedure and/or on different occasions e.g. on different dates.

In some embodiments, at least some of the data can include, or can be determined from medical imaging data, for instance obtained using a scanner 24. The scanner 24 may be configured to generate medical imaging data, which may comprise two-, three- or four-dimensional data in any imaging modality. For example, the scanner 24 may comprise a magnetic resonance (MR or MRI) scanner, CT (computed tomography) scanner, cone-beam CT scanner, X-ray scanner, ultrasound scanner, PET (positron emission tomography) scanner or SPECT (single photon emission computed tomography) scanner. The medical imaging data may comprise or be associated with additional conditioning data, which may for example comprise non-imaging data.

The computing apparatus 22 may receive data from one or more further data stores (not shown) instead of or in addition to data store 30. For example, the computing apparatus 22 may receive medical image data from one or more remote data stores (not shown) which may form part of a Picture Archiving and Communication System (PACS) or other information system.

Computing apparatus 22 provides a processing resource for automatically or semi-automatically processing the data. Computing apparatus 22 comprises a processing apparatus 32. The processing apparatus 32 comprises model training circuitry 34 configured to train one or more models; data processing circuitry 36 configured to apply trained model(s) and to perform other processes for example inference and graph generation processes; and interface circuitry 38 configured to obtain user or other inputs and/or to output results of the data processing.

In the present embodiment, the circuitries 34, 36, 38 are each implemented in computing apparatus 22 by means of a computer program having computer-readable instructions that are executable to perform the method of the embodiment. However, in other embodiments, the various circuitries may be implemented as one or more ASICs (application specific integrated circuits) or FPGAs (field programmable gate arrays).

The computing apparatus 22 also includes a hard drive and other components of a PC including RAM, ROM, a data bus, an operating system including various device drivers, and hardware devices including a graphics card. Such components are not shown in FIG. 1 for clarity.

The data processing apparatus 20 of FIG. 1 is configured to perform methods as illustrated and/or described in the following.

Embodiments may be used to determine causality in a variety of data of different types. For example, knowledge of causality is important for estimating the effect of possible interventions on a patient or other subject, for example the effect of administration of a drug, or performance of surgery or a particular surgical procedure. For instance, it may be desired to learn the interactions in or structure of cellular signaling networks, protein networks or other biological networks.

In other embodiments, the establishment of causal relationships may be used to determine biomarkers that correspond to changes in physiological parameters, or in determining causes of disease, or in clinical decision making. In some embodiments, a causal relationship between one or more features of treatments provided to patients or other subjects and treatment outcomes may be determined. Methods according to embodiments may also be used to select features for input to machine learning models. For example, if the machine learning model is trained, or to be trained, to determine a particular parameter value or set of parameter values from a set of inputs, then it may be beneficial to select inputs for use with the model that have a causal relationship with the parameter or parameters. The methods of some embodiments may be used to validate data collection. For example, if a determined order of causation between different parameters is not what was expected then it could indicate a problem of data collection, and for example may be used to change what parameters are measured when determining or monitoring a condition of interest, for example a medical condition suffered by a patient or other subject.

Processes according to embodiments can be used to take a set of d variables, also referred to as parameters, and to learn relations between then, given n data samples.

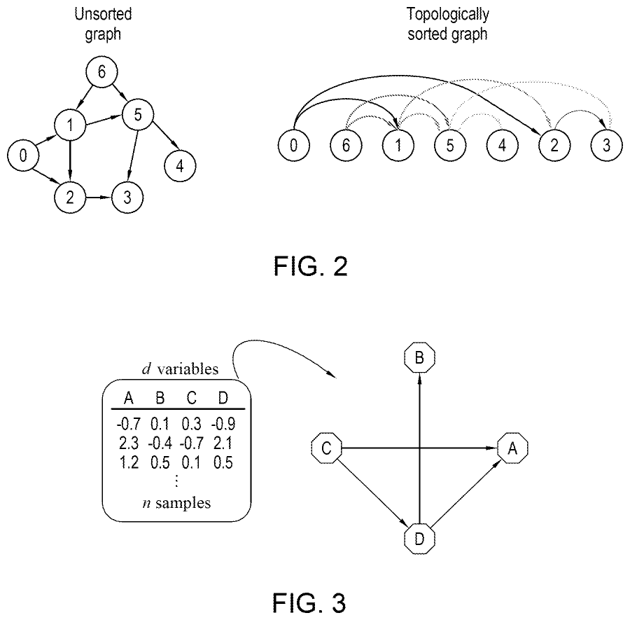

An example of an unsorted graph and a topologically sorted graph resulting from application of a causal discovery process to data represented by the graphs is illustrated in FIG. 2. Arrows indicate causal relationships between different parameters numbered 1 to 6.

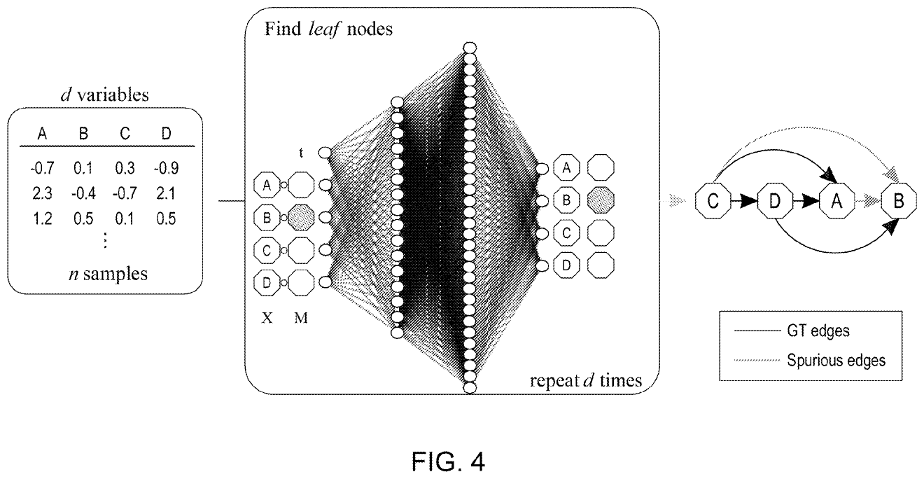

Similarly, FIGS. 3 and 4 illustrate schematically a process of learning causal relations between d variables (e.g. A, B, C and D) using a dataset of n samples. FIG. 4 shows the process in more detail. An iterative process is performed d times. At each iteration, one leaf node is found. In the subsequent iteration, the previous leaves are removed, reducing the search space. After topological ordering (as illustrated on the right side), the presence of edges (causal mechanisms) between variables can be inferred such that parents of each variable are selected from the preceding variables in the ordered list. Spurious edges can be pruned with feature selection as a post-processing step if desired.

In various embodiments, observational data can be considered to represent information that is gathered passively, in contrast to interventional data which comes from, for example, trials or experiments. Either or both type of data may be used if desired. A causal relation may be considered to be present when one variable in a data set has a direct influence on another variable. Causal discovery can be considered to be the causal relationships between variables. A score used in the causal discovery process may comprise, represent, or be derived from gradient of a data distribution w.r.t to the input e.g. ∇log p(x).

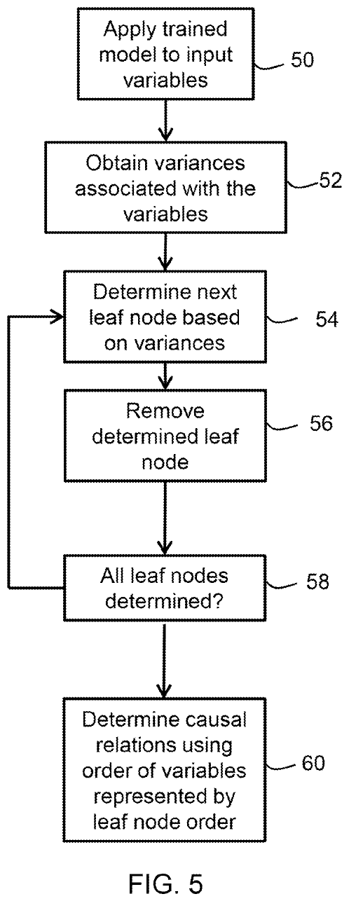

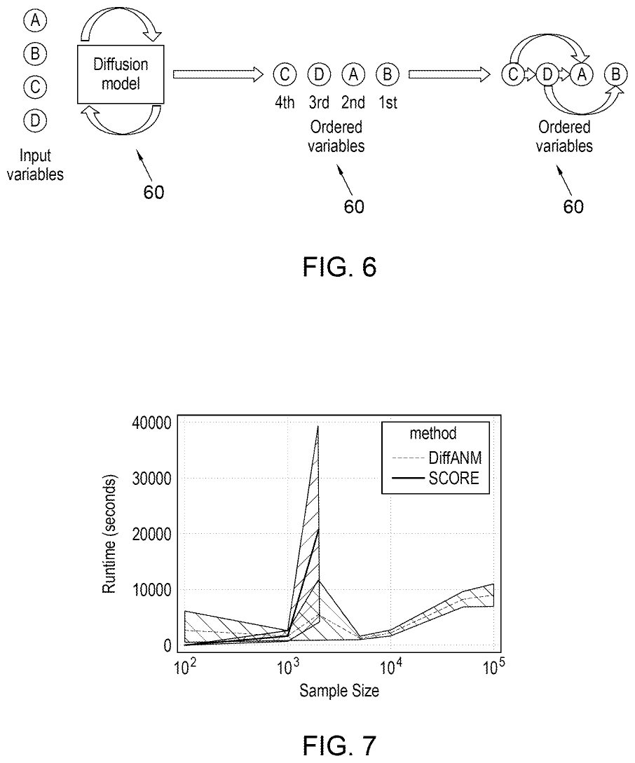

A process according an embodiment is illustrated schematically in the flow chart of FIG. 5. The same process is also illustrated, by way of example, in FIG. 6, which shows the process applied to a set of four input variables A, B, C and D.

At a first stage 50 of the process a trained model is retrieved from data store 30 and n data samples of the set of d variables are then input to the trained model by the processing circuitry 36. The trained model in this embodiment has been trained by model training circuitry and is a structural causal model (SCM) in the form of an additive noise model (ANM) that is a diffusion model with denoising loss.

The output of the trained diffusion model is a score that is representative of a distribution of parent and child relationships between the variables. In some variants, the output of the diffusion model is approximately the same as would be obtained by applying the techiques of, for example, Song, Y., Sohl-Dickstein, J., Kingma, D. P., Kumar, A., Ermon, S. and Poole, B., 2020, Score-Based Generative Modeling through Stochastic Differential Equations. In International Conference on Learning Representations. In other variants or embodiments any other suitable model, and resulting outputs, may be used.

The score that is the output of the trained model may represent or be derived from the probability of each possible set of parent and child relationships being the correct one, given the measured values of the variable(s). The score can thus be considered to be in the form of a probability distribution.

At the next stage 54, the variable that corresponds to the next leaf node (initially, the first leaf node) is determined using the output from the trained model. In particular, an inference process is run over a batch, then a backpropagation process is performed and for each sample partial derivatives are taken with respect to inputs giving a dxd Hessian matrix.

The variance for each element of the matrix diagonal is then calculated. Then, at stage 56, the element (variable) with lowest variance v_{L} is identified as the next leaf node.

The contribution of v_{L} for the identified leaf node is subtracted from the score. Effectively, this can be considered as masking of the leaf node and/or its contribution to the score.

It is then determined at stage 58 whether all leaf nodes have been determined. If not, then the process returns to stage 54 and stages 54, 56 and 58 are repeated until all nodes are assigned. In some embodiments the algorithm used at 54, 56 and 58 is Algorithm 1 set out below. The algorithm can also be referred to using the name DiffAN.

Then, at stage 60 causal relations are determined from the order of variables represented by the leaf node order. In some embodiments, a pruning technique such as that discussed in Bühlmann et al. CAM: Causal Additive Models, High-Dimensional Order Search and Penalized Regression, Annals of Statistics 2014, Vol. 42, No. 6 (December 2014), pp. 2526-2556 may be used at stage 60.

In some embodiments, the determining of the variances comprises applying a neural network, which is trained with denoising diffusion, to the dataset to estimate the variances, which are second order derivatives of a distribution associated with the variables, the determining of the order of the variables includes re-applying the same neural network, without retraining, to the dataset after each iterative removal of at least one node or variable to re-determine the variances, each iterative removal of at least one node or variable is based on a score, and the scores for new distributions resulting from the iterative removals of at least one node or variable are determined based on the re-determined variances.

The stages of the process of FIG. 5 are also illustrated schematically in the diagram of FIG. 6, which shows the process being used to obtain a causal graph for four variables A, B, C and D.

The embodiment enables an order of variables, of a dataset comprising d variables and n samples of values of the variables, to be determined based on variances that are determined in a procedure that includes processing the dataset using a trained model. The determining of the order includes iteratively removing variables and/or nodes. The method can be used to determine a causation relationship between the variables, for example a topology of a causation graph. The variances comprise variances of derivatives of a score in respect of each variable. The variances can comprise or be represented by a Jacobian or Hessian, or may be second order derivatives of a data distribution represented by or derived from the data set.

The data to which the embodiment FIG. 1 may be applied can be any suitable data for determination of any causal relationships of interest, for example the data may represent expression levels of proteins and phospholipids and be used to determine a protein signalling network. Any other suitable data may be used, or causal relationships determined, in other embodiments.

For example, the data may comprise data that includes or represents at least one of: drug dosages given to a patient or other subject; physiological or other measurements performed on the patient; one or more of blood pressure, temperature, heart rate, blood oxygenation, electrocardiograph or other electrical measurements; vision or hearing-related measurements; measurements of any of a patient's or other subject's senses or reactions or any other measurements; or at least one of age, height, weight or other patient data, any suitable data relating to an imaging or other procedure. The data may include temporal data, and the causal relationships may include causal relationships that have a time dependence. For example, there may be time lags between cause and effect for at least some of the relationships.

FIG. 7 is a plot showing run time in seconds for different sample sizes, for discovery of causal graphs with 500 nodes, obtained by performing a method by the embodiment of FIGS. 1, 5 and 6 (also referred to as the DiffAN method). Most known causal discovery methods have prohibitive run time and memory cost for datasets with many samples. By way of example, the same data sets were also processed using the known SCORE algorithm (Rolland, P et al, Score Matching Enables Causal Discovery of Nonlinear Additive Noise Models. ICML 2022, pp. 18741-18753) and the results are also shown in FIG. 7 for comparison purposes. The SCORE algorithm in this example cannot be computed beyond 2000 samples in a machine with 64 GB of RAM. By contrast, the DiffAN method according to embodiments can be seen to have a reasonable run time even for numbers of samples two orders of magnitude larger than the upper limit of at least some known methods.

The embodiment of FIG. 1 enables scalable causal discovery by utilising a neural network (NN), or other model, trained with denoising diffusion. An ordering procedure is used, which requires re-computing the score's Jacobian at each iteration. Training the NN or other model at each iteration would not be feasible. Instead, the algorithm provides for updating the learned score without re-training. In addition, the NN or other model is trained over the entire dataset (n samples) but a sub-set of the data set can be used for finding leaf nodes. Thus, once the score model is learned, it can be used to order the graph with constant complexity on n, enabling causal discovery for large datasets in high-dimensional settings. The algorithm does not require architectural constraints on the neural network. According to certain embodiments, the training procedure for the model does not learn the causal mechanism directly, but instead is trained on the score of the data distribution.

Embodiments provide an identifiable algorithm leveraging a diffusion probabilistic model for topological ordering that enables causal discovery assuming an additive noise model. In some embodiments, scaling to datasets with up to 500 variables and up to 105 or more samples is provided. The score estimated with the diffusion model is used to find and remove leaf nodes iteratively, The second-order derivatives (e.g. the score's Jacobian or Hessian) of a data distribution can be estimated using a neural network or other model with diffusion training via backpropagation. The score used in at least some embodiments, also referred to as deciduous score, allows efficient causal discovery without re-training the score model at each iteration, e.g. without using a re-trained or differently-trained score model at each iteration. When a leaf node is removed, the score of the new distribution can be estimated from the original score (before leaf removal) and its Jacobian or Hessian.

In the embodiments of FIGS. 5 and 6, implemented using the system of FIG. 1, the trained model is a neural network (NN) trained with a DPM objective to perform topological ordering and followed by a pruning post-processing step (for example a pruning step as described in Bühlmann et al. CAM: Causal Additive Models, High-Dimensional Order Search and Penalized Regression, Annals of Statistics 2014, Vol. 42, No. 6 (December 2014), pp. 2526-2556). With regard to the neural network architecture, a 4-layer multilayer perceptron (MLP) with LeakyReLU and layer normalization is used in some embodiments. With regard to metrics, one or more of structural Hamming distance (SHD), Structural Intervention Distance (SID), Order Divergence and run time in seconds may be used. Any other suitable neural network architecture and/or metrics and/or training process may be used in other embodiments. For example, any suitable number and arrangement of layers of the neural network may be used, or any other suitable trained model may be used as well as or instead of the neural network. The number and arrangement of the layers, or other features of the model, may be selected, for example, depending on the number of input variables and the expected or actual complexity of the causal graph.

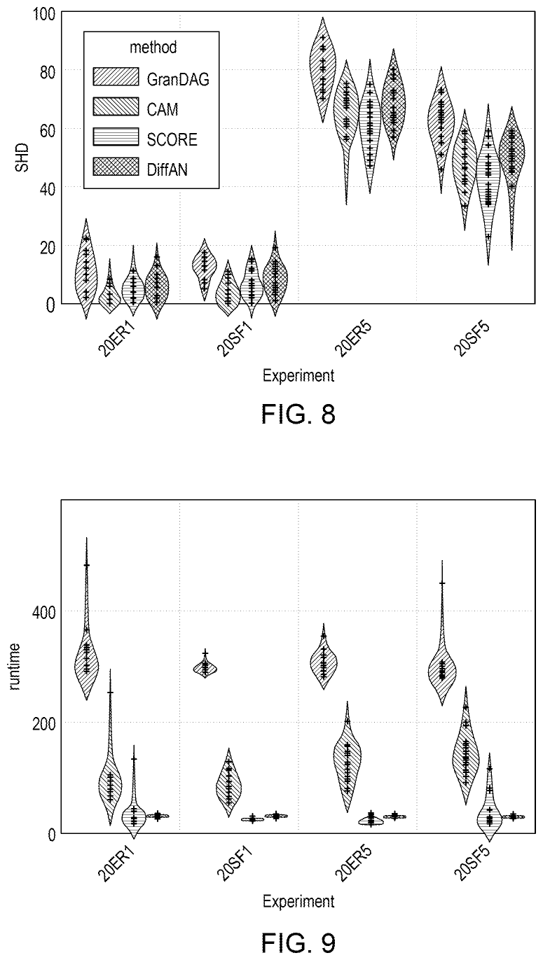

FIGS. 8 and 9 shows results of experiments on synthetic data graphs for graphs with nodes using the method according to an embodiment. FIG. 8 shows SHD values and FIG. 9 shows run time in seconds. The variation in the violin plots come from 3 different seeds over dataset generated from 3 different noise type and 3 different noise scales. A total of 27 experiments were run for each method and synthetic datasets type.

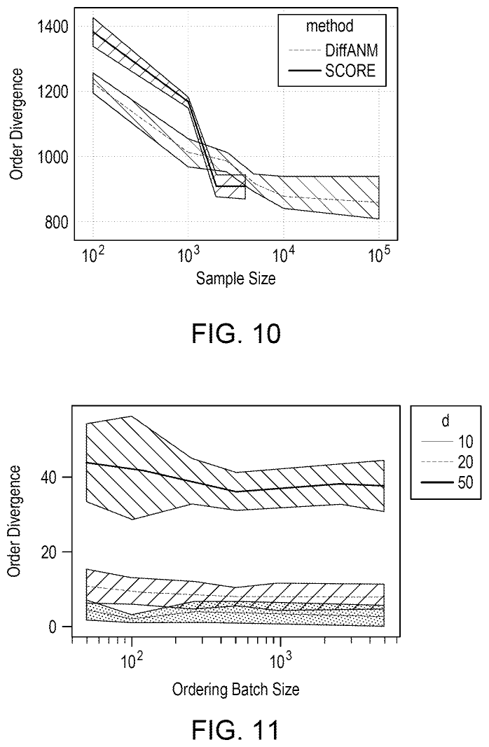

FIGS. 10 and 11 are plots that illustrate the variation in accuracy of a method according to an embodiment, as the dataset size is scaled up for datasets with 500 variables and increasing numbers of data samples n (FIG. 10) and as the batch size for computing the Hessian variance is changed (FIG. 11). 95% confidence intervals are indicated over 6 datasets which have different graph structures sampled different graph types.

Further details of the experiments conducted to obtain the results shown in FIGS. 8, 9, 10, and 11 are described in Sanchez et al, Diffusion Models for Causal Discovery via Topological Ordering, ICLR 2023, arXiv:2210.06201, which is incorporated by reference herein in its entirety.

Further details of techniques that may be included in embodiments, for example the embodiment of FIGS. 1, 5 and 6, as well as various mathematical proofs or comments, are now provided below. At least some of the following description is also included in Sanchez et al, Diffusion Models for Causal Discovery via Topological Ordering, ICLR 2023, arXiv:2210.06201, which is incorporated by reference herein in its entirety.

The problem of discovering the causal structure between d variables, given a probability distribution p(x) from which a d-dimensional random vector x=(x₁, . . . , x_{d}) can be sampled is considered. It is assumed that the true causal structure is described by a DAG [symbol] containing d nodes. Each node represents a random variable xᵢ and edges represent the presence of causal relations between them. In other words, it can be said that [symbol] defines a structural causal model (SCM) consisting of a collection of assignments xᵢ:=ƒᵢ(Pa(xᵢ), ∈ᵢ), where Pa(xᵢ) are the parents of xᵢ in [symbol] , and ∈ᵢ is a noise term independent of x₁, also called exogenous noise. εᵢ are i.i.d. from a smooth distribution p^{∈}. The SCM entails a unique distribution p(x)=Πᵢ₌₁^{d}p(xᵢ|Pa(xᵢ)) over the variables x. The observational input data are X∈ [symbol] ^{n×d}, where n is number of samples. The target output is an adjacency matrix A∈ [symbol] ^{d×d}.

The topological ordering (also called causal ordering or causal list) of a DAG [symbol] is considered as a non-unique permutation π of d nodes such that a given node always appears first in the list than its descendants. Formally, πᵢ<πⱼ⇔j∈ [symbol] (xᵢ) where [symbol] (xᵢ) are the descendants of the ith node in [symbol] (Appendix B in Peters et al, Elements of Causal Interference, MIT Press, 2017).

Learning a unique A from X with observational data requires additional assumptions. A known class of methods called additive noise models (ANM) explores asymmetries in the data by imposing functional assumptions on the data generation process. In most cases, they assume that assignments take the form xᵢ:=ƒᵢ(Pa(xᵢ))+∈ᵢ with ∈ᵢ˜p^{∈}. Here we focus on the case described by where ƒᵢ is nonlinear. The notation ƒᵢ for ƒᵢ(Pa(xᵢ)) is used because the arguments of ƒᵢ will be Pa(xᵢ ) herein. ƒᵢ does not depend on i.

Identifiability. It is assumed that the SCM follows an additive noise model (ANM) which is known to be identifiable from observational data. Causal sufficiency is also assumed, i.e. there are no hidden variables that are a common cause of at least two observed variables. In addition, it is taken that the true topological ordering of the DAG, as in our setting, is identifiable from a p(x) generated by an ANM without requiring causal minimality assumptions.

Finding Leaves with the Score. The score of an ANM with distribution p(x) may be used to find leaves (where nodes without children in a DAG [symbol] are referred to as leaves). Before presenting how to find the leaves, an analytical expression for the score is derived, which can be written as:

$$\begin{matrix}{∇}_{{x}_{j}} log p ( x ) = {∇}_{{x}_{j}} log {\prod }_{i = 1}^{d} p ( {x}_{i} \vert Pa ( {x}_{i} ) ) \\ = {∇}_{{x}_{j}} {\sum }_{i = 1}^{d} log p ( {x}_{i} \vert Pa ( {x}_{i} ) ) \\ = {∇}_{{x}_{j}} {\sum }_{i = 1}^{d} log {p}^{ϵ} ( {x}_{i} - {f}_{i} ) ⊳ Using {ϵ}_{i} = {x}_{i} - {f}_{i} \\ = \frac{\partial log {p}^{ϵ} ( {x}_{j} - {f}_{j} )}{\partial {x}_{j}} - {\sum }_{i ∈ Ch ( {x}_{j} )} \frac{\partial {f}_{i}}{\partial {x}_{j}} \frac{\partial log {p}^{ϵ} ( {x}_{i} - {f}_{i} )}{\partial x} .\end{matrix} \qquad ( equation 1 )$$

Where Ch(xⱼ) denotes the children of xⱼ.

Lemma 1. Given a nonlinear ANM with a noise distribution p^{∈} and a leaf node j; assume that

$$\frac{{\partial }^{2} log {p}^{ϵ}}{\partial {x}^{2}} = a ,$$

where α is a constant, then

Varₓ[H_{j,j}(log p(x))]=0. (equation 2)

Remark 1. Lemma 1 enables finding leaf nodes based on the diagonal of the log-likelihood's Hessian.

An efficient algorithm for learning the Hessian at high-dimensions and for a large number of samples is developed according to embodiments. A formulation is derived which requires the second-order derivative of the noise distribution to be constant. Indeed, the condition

$$\frac{{\partial }^{2} log {p}^{ϵ}}{\partial {x}^{2}} = a$$

is true tor p^{∈} tollowing a Gaussian distribution, but could potentially be true for other distributions as well.

### Diffusion Models Approximate the Score

The process of learning to denoise can approximate that of matching the score . A diffusion process gradually adds noise to a data distribution over time. Diffusion probabilistic models (DPMs) learn to reverse the diffusion process, starting with noise and recovering the data distribution. The diffusion process gradually adds Gaussian noise, with a time-dependent variance αₜ, to a sample x₀˜p_{data}(x) from the data distribution. Thus, the noisy variable xₜ, with t∈[0, T], is learned to correspond to versions of x₀ perturbed by Gaussian noise following p(x|ₜ|x₀)= [symbol] (xₜ; \sqrt{αₜ}x₀, (1−αₜ)I), where αₜ:=Πⱼ₌₀^{t}(1−βⱼ), βⱼ is the variance scheduled between [βₘᵢₙ, βₘₐₓ] and I is the identity matrix. DPMs are learned with a weighted sum of denoising score matching objectives at different perturbation scales with

$${θ}^{*} = {arg min}_{θ} {𝔼}_{{x}_{0} , t , ϵ} [ λ ( t ) {‖ {ϵ}_{θ} ( {x}_{t} , t ) - ϵ ‖}_{2}^{2} ] , \qquad ( equation 3 )$$

where xₜ=\sqrt{αₜ}x₀+\sqrt{1−αₜ}∈, with x₀˜p(x) being a sample from the data distribution, t˜ [symbol] (0, T) and ∈˜ [symbol] (0, I) is the noice. λ(t) is a loss weighting term following.

Remark 2. The fact that the trainedmodel ∈_{θ} approximates the score ∇ₓⱼlog p(x) of the data is leveraged.

### The Deciduous Score

Discovering the complete topological ordering with the distribution's Hessian can be done by finding the leaf node, appending the leaf node x₁ to the ordering list π it and removing the data column corresponding to x₁ from X before the next iteration d−1 times.

Certain embodiments do not require estimation of a new score after each leaf removal. In particular, the score of a distribution can be adjusted after each leaf removal, and this can be referred to, for example, as a “deciduous score”. An analytical expression for the deciduous score is obtained and a way of computing it is derived, based on the original score before leaf removal. In this section, it is considered that p(x) follows a distribution described by an ANM, with no additional assumptions over the noise distribution.

Definition 1. Considering a DAG [symbol] which entails a distribution p(x)=∅ᵢ₌₁^{d}P(xᵢ|Pa(xᵢ)). Let

$$p ( {x}_{- l} ) = \frac{p ( x )}{p ( {x}_{l} \vert Pa ( {x}_{l} ) )}$$

be p(x) without the random variable corresponding to the leaf node x_{I}. The deciduous score ∇log p(X_{-I})∈ [symbol] ^{d-1} is the score of the distribution p(x_{-I}).

Lemma 2. Given a ANM which entails a distribution p(x), Equation 1 can be used to find an analytical expression for an additive residue Δ_{I} between the distribution's score ∇log p(x) and its deciduous score ∇log p(x_{-I}) such that

Δ_{ι}=∇log p(x)−∇log p(x_{-ι}). (equation 4)

In particular, Δ_{ι} is a vector {δⱼ|℄j∈[1, . . . , d]\ι} where the residue w.r.t a node xⱼ can be denoted as

$$\begin{matrix}{δ}_{j} = {∇}_{{x}_{j}} log p ( x ) - {∇}_{{x}_{j}} log p ( {x}_{- l} ) \\ = - \frac{\partial {f}_{i}}{\partial {x}_{j}} \frac{\partial log {p}^{ϵ} ( {x}_{i} - {f}_{i} )}{\partial x} .\end{matrix} \qquad ( equation 5 )$$

If xⱼ∉Pa(x_{ι}), δⱼ=0.

Proof. Observing Equation 1, the score ∇ₓⱼlog p(x) only depends on the following random variables (i) Pa,(xⱼ), (ii) Ch(xⱼ), and (iii) Pa(Ch(xⱼ)).

x_{ι} is considered to be a leaf node, therefore ∇ₓⱼlog p(x) only depends on x_{ι} if xⱼ∈Pa(x_{ι}). If xⱼ∈Pa(x_{ι}), the only term depending on ∇ₓⱼlog p(x) dependent on x_{ι} is one of the terms inside the summation.

It may be desired to estimate the deciduous score ∇log p(x_{-ι}) without direct access to the functiion ƒ_{ι}, to its derivative, nor to the distribution p^{∈}. Therefore, an expression for Δ_{ι} is derived using solely the score and the Hessian of log p(x).

Theorem 1. Consider an ANM of distribution p(x) with score ∇log p(x) and the score's jacobian H(log p(x)). The additive residue Δ_{ι} necessary fir computing the deciduous score (as in Propsosition 2) can be estimated with

$${Δ}_{l} = {H}_{l} ( log p ( x ) ) \cdot \frac{{∇}_{{x}_{l}} log p ( x )}{{H}_{l , l} ( log p ( x ) )} . \qquad ( equation 6 )$$

### Causal Discovery with Diffusion Models

DPMs approximate the score of the data distribution. It is explored how to use DPMs to perform leaf discovery and compute the deciduous score for iteratively finding and removing leaf nodes without re-training the score.

### Approximating the Score's Jacobian via Diffusion Training

The score's Jacobian can be approximated by learning the score ∈_{θ} with denoising diffusion training of neural networks and back-propagating (the Jacobian of a neural network can be efficiently computed with auto-differentiation libraries such as functorch) from the output to the input variables. It can be written, for an input data point x∈ [symbol] ^{d}, as

H_{i,j} log p(x)≈∇_{i,j}∈_{θ}(x, t), (equation 7)

where ∇_{i,j}∈_{ι}(x, t) means the ith output of ∈_{θ} is backpropagated to the jth input. The diagonal of the Hessian in Equation 7 can, then, be used for finding leaf nodes as in Equation 2.

In a two variable setting, it is sufficient for causal discovery to (i) train a diffusion model (Equation 3); (ii) approximate the score's Jacobian via backpropagation (Equation 7); (iii) compute variance of the diagonal across all data points; (iv) identify the variable with lowest variance as effect (Equation 2).

### Topological Ordering

When a DAG contains more than two nodes, the process of finding leaf nodes (i.e. the topological order) needs to be done iteratively as illustrated, for example, in FIG. 4. The naive (greedy) approach would be to remove the leaf node from the dataset, recompute the score, and compute the variance of the new distribution's Hessian to identify the next leaf node. Since diffusion models are employed to estimate the score, this equates to re-training the model each time after a leaf is removed.

A method is therefore proposed to compute the deciduous score ∇log p(x_{-ι}) using Theorem 1 to remove leaves from the initial score without re-training the neural network. In particular, assuming that a leaf x_{ι} is found, the residue Δ_{ι} can be approximated with

$${Δ}_{l} ( x , t ) \approx {∇}_{l} {ϵ}_{θ} ( x , t ) \cdot \frac{{{ϵ}_{θ} ( x , t )}_{l}}{{∇}_{l , l} {ϵ}_{θ} ( x , t )} \qquad ( equation 8 )$$

where ∈_{θ}(x, t)_{ι} is output corresponding to the leaf node. The diffusion model itself is an approximation of the score, therefore its gradients are approximations of the score derivatives.

Note that the term ∇_{ι}∈_{θ}(x, t) is a vector of size d and the other term is a scalar. During topological ordering Δ_{π}, is computed which is the summation of Δ_{ι} over all leaves already discovered and appended to rc. Naturally, only Δ_{ι} w.r.t. nodes xⱼ∉π are computed because xⱼ∈π have already been ordered and are not taken into account anymore.

In practice, it is observed that training ∈_{θ} on X but using a subsample B∈ [symbol] ^{k×d} of size k randomly sampled from X increases speed without compromising performance. In addition, analysing Equation 5, the absolute value of the residue δ_{ι} decreases if the values of x_{ι} are set to zero once the leaf node is discovered. Therefore, a mask M_{π}∈{0,1}^{k×d} is applied over leaves discovered in the previous iterations and only the Jacobian of the outputs corresponding to x_{-ι} is computed. M_{π} is updated after each iteration based on the ordered nodes π. A leaf node is then found according to

leaf=argmin_{xi∈x} Var_{b}[∇ₓ(score(M_{π}⊙B, t))], (equation 9)

where ∈_{θ} is a DPM trained with Equation 3. This topological ordering procedure is formally described in Algorithm 1, score(−π) means and only the outputs for nodes xⱼ∉π are considered.

Algorithm 1: Topological Ordering with DiffAN
Input: X ∈ [symbol] ^{n×d}, trained diffusion model ϵ_{θ}, ordering
batch size k
π = [ ], Δ_{π} = 0^{k×d}, M_{π} = 1^{k×d}, score = ϵ_{θ}
while ∥π∥ ≠ d do

| | | |
|---|---|---|
| \| | $B {←}^{k} X$ | / / Randomly sample a batch of k elements |

| | | |
|---|---|---|
| \| | B ← B ∘ M_{π} | / / Mask removed leaves |

| | | |
|---|---|---|
| \| | Δ_{π} = GetΔ_{π}(score, B) | / / Sum of Equation 8 over π |
| \| | score = score(−π) + Δ_{π} | / / Update score with residue |

| | | |
|---|---|---|
| \| | leaf = GetLeaf(score, B) | / / Equation 9 |

| | | |
|---|---|---|
| \| | π = [leaf, π] | / / Append leaf to ordered list |
| \| | M_{t,leaf} = 0 | / / Set discovered leaf to zero |

end

Output: Topological order π

### Computational Complexity and Practical Considerations

The complexity of topological ordering with DiffAN w.r.t. the number of samples n and number of variables d in a dataset are studied. The complexities of a greedy version, as well as approximation which only utilises masking, are discussed. DiffAN is used to refer to a method according to one embodiment.

Complexity on n. Methods according to some embodiments separate learning the score ∈_{θ} from computing the variance of the Hessian's diagonal across data points. All n samples in X for learning the score function with diffusion training (Equation 3) can be used. Expensive constrained optimisation techniques (for example, the Augmented Lagrangian method) do not have to be used, and the model can be trained for a fixed number of epochs (which is linear with n) or until reaching the early stopping criteria. An MLP can be used that grows in width with d but it does not significantly affect complexity. Therefore, training can be considered to be O(n). Moreover, Algorithm 1 is computed over a batch B with size k<n instead of the entire dataset X, as described in Equation 9. The number of samples k in B can be arbitrarily small and constant for different datasets. It can be verified that the accuracy of causal discovery initially improves as k is increased but eventually tapers off.

Complexity on d. Once ∈_{θ} is trained, a topological ordering can be obtained by running ∇ₓ∈_{θ}(X, t) d times. Moreover, computing the Jacobian of the score requires back-propagating the gradients d−i times, where i is the number of nodes already ordered in a given iteration. Finally, computing the deciduous score's residue (Equation 8) means computing gradient of the i nodes. Resulting in a complexity of O(d·(d−i)·i) with i varying from 0 to d which can be described by O(d³). The final topological ordering complexity is therefore O(n+d³).

DiffAN Masking. It has been verified empirically that the masking procedure can significantly reduce the deciduous score's residue absolute value while maintaining causal discovery capabilities. In DiffAN Masking, the ∈_{θ} is not retrained and the deciduous score does not have to be re-computed. This ordering algorithm is an approximation but has shown to work well in practice while showing remarkable scalability. DiffAN Masking has O(n+d²) ordering complexity.

Features of certain embodiments, and optional features of such embodiments, are as follows.

According to certain embodiments, there is provided a data processing apparatus comprising:
a memory configured to store a trained model, for example a diffusion model, which may be trained on n samples; and
processing circuitry configured to:
   receive at least one dataset, optionally that comprises d variables and n samples;
   determine variances associated with the variables, for example by processing the dataset using the model; and
   determine an order of the variables based on the determined variances.

The determining of the order may comprise removing at least one node and/or variable represented by said at least one node thereby to determine the order, optionally iteratively removing variables and/or nodes thereby to determine the order.

The order of the variables may represent an order of causation relationship(s).

The variances may comprise variances of derivatives, optionally second order derivatives of the data, and/or a respective one of the variances may be associated with each variable.

The determining of the variances may comprise determining a variance of a second order gradient of a distribution associated with the variables.

The determining of the variances may comprise applying a neural network, which is trained with denoising diffusion, to the dataset to estimate the variances, which are second order derivatives of a distribution associated with the variables. The determining of the order of the variables may include re-applying the same neural network, without retraining, to the dataset after each iterative removal of at least one node or variable to re-determine the variances. Each iterative removal of at least one node or variable may be based on a score, and the scores for new distributions resulting from the iterative removals of at least one node or variable may be determined based on the re-determined variances.

The determining of the order of the variables may comprise determining a causation graph.

The processing circuitry may be further configured to determine a causation relationship between the variables, for example a topology of a causation graph, based on the determined order of the variables.

The processing circuity may be configured to select parent variable(s) for each variable from preceding variable(s) in the order, wherein optionally the selecting comprises an inference procedure and/or is followed by a pruning procedure to remove incorrect causal relationships.

The variances may comprise variances of derivatives of a score in respect of each variable.

The score may represent a gradient of a data distribution of the data set.

The variances may comprise or be represented by a Jacobian or Hessian.

The variances may comprise second order derivatives of a data distribution represented by or comprised in the data set.

The processing circuitry may be further configured to determine the variances based on a score, wherein the score may be calculated by processing the at least one dataset by the model.

The score may comprise, represent or be determined from gradients generated by processing the dataset by the model.

The order of the variables may comprise or be represented by an order of nodes of a causal graph, for example a directed acyclic graph (DAG).

The processing circuitry may be further configured to determine a leaf node that corresponds to a peripheral one of the variables, for example based on the score.

The processing circuitry may be further configured to determine an order subsequent to the leaf node by masking the leaf node and determining the variances except for the leaf node, for example determining the variances without using variable(s) represented by the leaf node.

The processing circuity may be configured to remove at least one node and/or variable represented by said at least one node, and optionally to re-determine the variances thereby to determine the order in respect of at least one further node of the nodes, for example to determine the next node/variable in the order.

The processing circuitry may be configured to perform an iterative procedure that comprises removing successive variable(s)/node(s) and re-determining variances to determine the next one(s) of the variable(s)/node(s) in the order.

The iterative procedure may comprise computing a score based on the variances, re-computing the score with at least one variable removed. The re-computing of the score may comprises re-computing the score based on the score and a Jacobian or Hessian derived from the score, and/or without re-computing or re-accessing at least one of the data distribution, the variances and/or their derivatives.

The iterative procedure and/or the re-determining of variances may be performed without re-training the model and/or may be performed without using a re-trained version of the model and/or may be performed using the same model.

The model may comprise at least one of a neural network, a generative model, a generative neural network, a diffusion model, a diffusion probabilistic model, a non-linear additive noise model. The variances may be ensembled over score predictions.

The data set may comprise data that includes or represents at least one of drug dosages given to a patient or other subject, physiological or other measurements performed on the patient, for example, blood pressure, temperature, heart rate, blood oxygenation, electrocardiograph or other electrical measurements, vision or hearing-related measurements, measurements of any of the patient's senses or reactions, or any other measurements, and/or age, height, weight or other patient data.

According to certain embodiments, there is provided a data processing method comprising:
accessing a trained model, for example a diffusion model;
receiving at least one dataset that comprises d variables and n samples;
determining variances associated with the variables by processing the dataset using the model; and determining an order of the variables based on the determined variances.

The determining of the variances may comprise removing at least one node and/or variable represented by said at least one node thereby to determine the order, optionally iteratively removing variables and/or nodes thereby to determine the order.

According to certain embodiments, there is provided a processing apparatus comprises processing circuitry that is configured to train a model to determine variances for variables of a dataset using the model, thereby to determine an order of the variables based on the determined variances.

According to certain embodiments, there is provided a method comprising training a model to determine variances for variables of a dataset using the model, thereby to determine an order of the variables based on the determined variances.

According to certain embodiments, there is provided a method for causal discovery, comprising:
receiving a set of input variables d;
receiving a dataset of n samples for the variables d;
determining a score;
estimating a variance of a derivative (e.g. a Jacobian) of the score obtained with respect to each of a plurality of nodes represented in the model;
estimating the score and its derivatives when a leaf node variable is removed; and
determining the causal relations, given the topological node ordering.

The score may be determined by applying a model to the dataset.

The estimating of the variance of the derivative may be obtained by applying at least one of a neural network, a generative model, a generative neural network, a diffusion model.

The derivative of the score may be computed by back-propagating through the diffusion model to find the derivative with respect to each of a plurality of inputs to the model/

The model may be not re-trained for each leaf node. Discovered leaf nodes may be masked out by setting the corresponding inputs to 0 or other suitable value.

The variance may be ensembled over score predictions, for example at different values of t.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Whilst certain embodiments are described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms and modifications as would fall within the scope of the invention.

1. A data processing apparatus comprising:
a memory configured to store a trained model; and
processing circuitry configured to:
receive at least one dataset that comprises d variables and n samples;
determine variances associated with the variables by processing the dataset using the model;
determine an order of the variables based on the determined variances, including iteratively removing at least one node or variable represented by said at least one node thereby to determine the order.

2. The data processing apparatus according to claim 1, wherein the order of the variables represents an order of causation relationship(s), the variances comprise second order derivatives, and wherein a respective one of the variances is associated with each variable.

3. The data processing apparatus according to claim 1, wherein the determining of the variances comprises determining a variance of a second order gradient of a distribution associated with the variables.

4. The data processing apparatus according to claim 1, wherein the determining of the variances comprises applying a neural network, which is trained with denoising diffusion, to the dataset to estimate the variances, which are second order derivatives of a distribution associated with the variables,
the determining of the order of the variables includes re-applying the same neural network, without retraining, to the dataset after each iterative removal of at least one node or variable to re-determine the variances,
each iterative removal of at least one node or variable is based on a score, and the scores for new distributions resulting from the iterative removals of at least one node or variable are determined based on the re-determined variances.

5. The data processing apparatus according to claim 1, wherein the processing circuity is configured to select parent variable(s) for each variable from preceding variable(s) in the order, wherein the selecting comprises an inference procedure and is followed by a pruning procedure to remove incorrect causal relationships.

6. The data processing apparatus according to claim 1, wherein the variances comprise variances of derivatives of a score in respect of each variable.

7. The data processing apparatus according to claim 6, wherein the score represents a gradient of a data distribution of the data set.

8. The data processing apparatus according to claim 1, wherein the variances comprise or are represented by a Jacobian or Hessian.

9. The data processing apparatus according to claim 1, wherein the processing circuitry is further configured to determine the variances based on a score, wherein the score is calculated by processing the at least one dataset by the model.

10. The data processing apparatus according to claim 9, wherein the score comprises, represents or is determined from gradients generated by processing the dataset by the model.

11. The data processing apparatus according to claim 1, wherein the order of the variables comprises or is represented by an order of nodes of a causal graph, for example a directed acyclic graph (DAG).

12. The data processing apparatus according to claim 9, wherein the processing circuitry is further configured to determine a leaf node that corresponds to a peripheral one of the variables based on the score.

13. The data processing apparatus according to claim 12, wherein the processing circuitry is further configured to determine an order subsequent to the leaf node by masking the leaf node and determining the variances without using variable(s) represented by the leaf node.

14. The data processing apparatus according to claim 11, wherein the processing circuity is configured to remove at least one node or variable represented by said at least one node, and to re-determine the variances thereby to determine the next node or variable in the order.

15. The data processing apparatus according to claim 1, wherein the processing circuitry is configured to perform an iterative procedure that comprises removing successive variable(s) or node(s) and re-determining variances to determine the next one(s) of the variable(s) or node(s) in the order.

16. The data processing apparatus according to claim 15, wherein the re-determining of variances is performed using the same trained model.

17. The data processing apparatus according to claim 1, wherein the model comprises at least one of a neural network, a generative model, a generative neural network, a diffusion model, a diffusion probabilistic model, a non-linear additive noise model.

18. The data processing apparatus according to claim 1, wherein the data set comprises data that includes or represents at least one of: drug dosages given to a patient or other subject; physiological or other measurements performed on the patient; one or more of blood pressure, temperature, heart rate, blood oxygenation, electrocardiograph or other electrical measurements; vision or hearing-related measurements; measurements of any of a patient's or other subject's senses or reactions or any other measurements; or at least one of age, height, weight or other patient data; data relating to an imaging or other procedure.

19. A data processing method comprising:
storing a trained model;
receiving at least one dataset that comprises d variables and n samples;
determining variances associated with the variables by processing the dataset using the model; and
determining an order of the variables based on the determined variances including iteratively removing variables and/or nodes thereby to determine the order.
